(19) United States
(12) Patent Application Publication
(10) Pub. No.: US 2014/0289259 A1
(43) Pub. Date: Sep. 25, 2014

(54) Social Cue Based Electronic Communication Ranking

(71) Applicant: MICROSOFT CORPORATION, Redmond, WA (US)

(72) Inventors: Leela S. Tamma, Fremont, CA (US); Katarzyna Anna Puchala, Mountain View, CA (US); Eric Tran, Mountain View, CA (US); Cheng H. Ho, Santa Clara, CA (US); Ivaylo G. Dimitrov, Mountain View, CA (US)

(73) Assignee: Microsoft Corporation, Redmond, WA (US)

(21) Appl. No.: 13/847,990

(22) Filed: Mar. 20, 2013

(51) Int. Cl. G06F 17/30

(52) U.S. Cl. CPC G06F 17/3053
USPC 707/748

(57) ABSTRACT

A set of electronic communications of different types that the user has sent and/or received, such as email messages, text messages, instant messages, and so forth is obtained. The set of electronic communications can be obtained in various manners, such as by searching the electronic communications of the user for those electronic communications that satisfy user provided search criteria. The electronic communications in the set of electronic communications are ranked according to various social cues that provide an indication of how the user interacts with individuals that are the senders or recipients of the electronic communications.

### BACKGROUND

As technology has advanced, computers have become increasingly commonplace. People use computers to communicate in a variety of different manners, such as using email, text messaging, instant messaging, and so forth. Users can save a large amount of these communications, which allows users to retrieve the communications at a later time but is not without its problems. One such problem is that if a user desires to retrieve a particular communication, the large volume of communications can make it difficult for the user to identify the particular communication that he or she desires to view, leading to a frustrating user experience.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, for each electronic communication in a set of electronic communications of a user, a score is generated for each of multiple social cues that indicate how the user interacts with an individual in the electronic communication. For each electronic communication in the set of electronic communications, a ranking for the electronic communication is generated based on the scores of the multiple social cues for the electronic communication, and an indication of the rankings for the set of electronic communications is output.

In accordance with one or more aspects, a system includes an electronic communication ranking module and a ranked electronic communication output module. The electronic communication ranking module is configured to generate, for each electronic communication in a set of electronic communications of a user, a ranking for the electronic communication based on scores of each of one or more of multiple social cues indicating how the user interacts with an individual in the electronic communication. The ranked electronic communication output module is configured to output the indication of the rankings for the set of electronic communications.

### BRIEF DESCRIPTION OF THE DRAWINGS

The same numbers are used throughout the drawings to reference like features.

FIG. 1 illustrates an example system implementing the social cue based electronic communication ranking in accordance with one or more embodiments.

FIG. 2 illustrates another example system implementing the social cue based electronic communication ranking in accordance with one or more embodiments.

FIG. 3 illustrates another example system implementing the social cue based electronic communication ranking in accordance with one or more embodiments.

FIG. 4 illustrates operation of an example electronic communication ranking module in accordance with one or more embodiments.

FIG. 5 is a flowchart illustrating an example process for generating social cue based rankings for electronic communications in accordance with one or more embodiments.

FIG. 6 is a flowchart illustrating an example process for adjusting weights associated with social cues in accordance with one or more embodiments.

FIG. 7 illustrates an example system generally that includes an example computing device that is representative of one or more systems and/or devices that may implement the various techniques described herein.

### DETAILED DESCRIPTION

Social cue based electronic communication ranking is discussed herein. A set of electronic communications of different types that the user has sent and/or received, such as email messages, text messages, instant messages, and so forth is obtained. The set of electronic communications can be all electronic communications of the user or subsets thereof, such as the electronic communications of the user that satisfy particular search criteria. The user can provide search criteria including an indication of one or more terms that he or she desires to search for (typically one or more characters such as a word fragment, a word, or a phrase, optionally expanded to generate one or more additional search terms (such as being expanded to include semantically similar terms and/or terms in other languages). Various other search criteria can additionally or alternatively be used, such as an indication of a type of electronic communication, a date or time range that the electronic communications are to fall in, and so forth. A collection of electronic communications of the user is searched, and a set of electronic communications that satisfy the search criteria is identified.

The electronic communications in the set of electronic communications are ranked according to various social cues. The rankings are determined by generating a weighted score for each electronic communication based on the social cues, the social cues providing an indication of how the user interacts with a particular individual that is the sender or recipient of the electronic communication. Different social cues can have different weights associated with them that indicate how much they contribute to an overall score for each electronic communication. The weighted score is generated for each electronic communication based on these social cues, and the set of electronic communications are ranked based on these weighted scores.

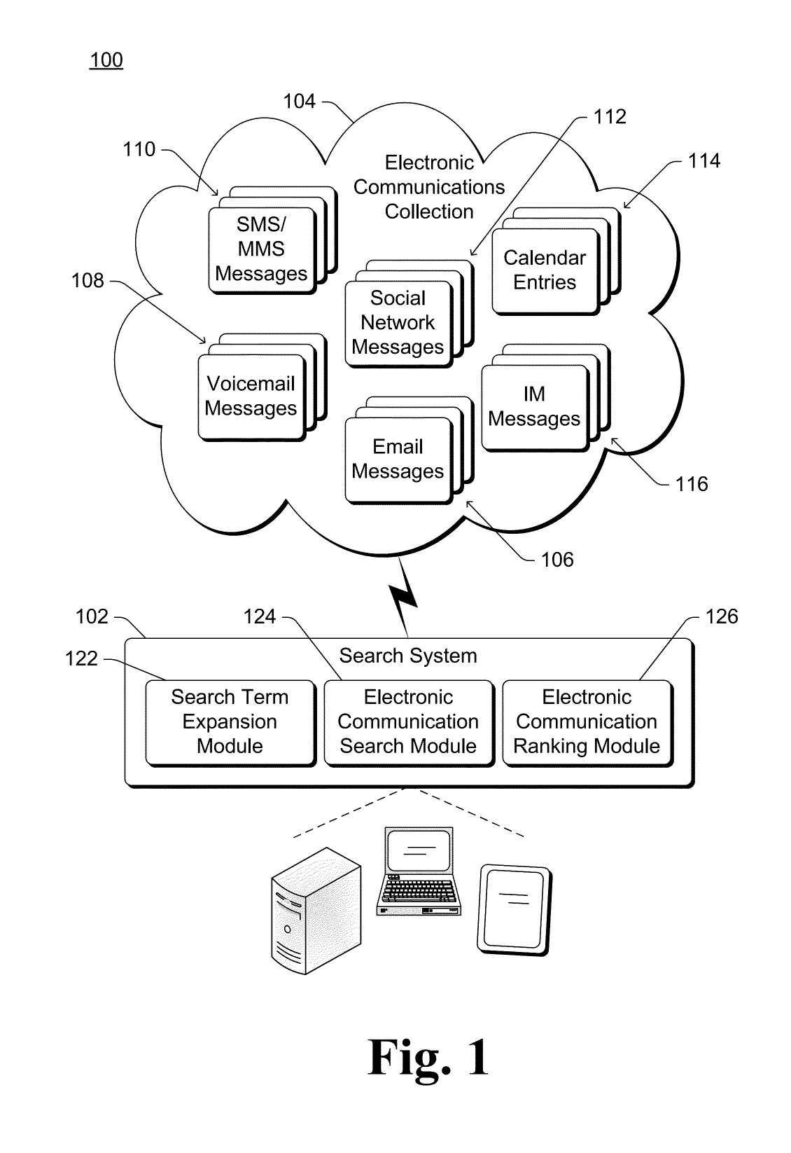

FIG. 1 illustrates an example system 100 implementing the social cue based electronic communication ranking in accordance with one or more embodiments. System 100 includes a search system 102 that can be implemented by one or more of a variety of different types of devices, such as a physical device or a virtual device. For example, search system 102 can be implemented by a physical device such as a desktop computer, a server computer, a laptop or netbook computer, a tablet or notepad computer, a mobile station, an entertainment appliance, a set-top box communicatively coupled to a display device, a television or other display device, a cellular or other wireless phone, a game console, an automotive computer, and so forth. Search system 102 can also be implemented by a virtual device, such as a virtual machine running on a physical device. A virtual machine can be run on any of a variety of different types of physical devices (e.g., any of the various types listed above). Thus, search system 102 can be implemented by devices ranging from a full resource device with substantial memory and processor resources (e.g., personal computers, game consoles) to a low-resource device with limited memory and/or processing resources (e.g., traditional set-top boxes, hand-held game consoles).

Search system 102 has access to a collection 104 of electronic communications of the user. The electronic communications collection 104 can be maintained on the same one or more devices as implement the search system 102 and/or on additional devices. For example, some of the electronic communications in collection 104 can be stored on a same device as implements the search system 102, and some of the electronic communications in collection 104 can be stored on another device accessible to the device that implements the search system 102. A device implementing at least part of the search system 102 can communicate with other devices using a variety of different networks, such as the Internet, a local area network (LAN), a phone network, an intranet, other public and/or proprietary networks, combinations thereof, and so forth.

Search system 102 can be implemented as part of a service or program that supports sending and/or receiving of electronic communications, such as an email service. Alternatively, search system 102 can be implemented separately from an email service or any other service or program that supports sending and/or receiving of electronic communications, but has access to the electronic communications sent and/or received by such other services or programs to perform the searching discussed herein.

Various different types of electronic communications can be included in the collection 104. The electronic communications collection 104 can include any type of electronic communication that the search system 102 can access, such as types of electronic communications sent or received as associated with an account of the search system 102 that the user logs into, types of electronic communications sent or received as associated with a service that the search system 102 can log into (e.g., the search system 102 may have access to a user name and password to access the user's social networking account), and so forth. The electronic communications can include, for example, email messages 106, voicemail messages 108, short message service (SMS) or multimedia messaging service (MMS) messages 110, social network messages 112, calendar entries 114, and instant messaging (1M) messages 116.

The email messages 106 refer to electronic mail messages sent or received by the user. The voicemail messages 108 refer to electronic copies of voicemail messages that have been sent and/or received by the user. The voicemail messages 108 can be audio messages or text versions (e.g., transcriptions) of audio messages. The SMS/MMS messages 110 refer to text or other media messages sent or received by the user in accordance with SMS and/or MMS protocols.

The social network messages 112 refer to messages sent or received by a user of a social networking service. These messages can be, for example, chat or email messages sent or received by way of the social networking service, comments posted on a wall of a social networking service, messages sent or received by way of a blogging or microblogging service, messages sent or received by way of other information network services, and so forth. The calendar entries 114 refer to various meetings or other entries that can be included in a calendaring program. For example, the calendar entries 114 can include meetings scheduled by the user or meetings that include the user but are scheduled by another individual, meeting invites regardless of whether accepted by the user, cancelled meetings, and so forth. The IM messages 116 refer to text or other media messages sent or received by the user in accordance with instant messaging or chat protocols.

Although examples of multiple different types of electronic communications are illustrated in the collection 104, it should be noted that search system 102 need not search all of these different types of electronic communications. For example, a particular user may not have some types of electronic communications (e.g., IM messages 116 or voicemail messages 108), in which case these types of electronic communications are not searched by the search system 102. By way of another example, the search system 102 may be configured to search only particular types of electronic communications. By way of another example, the search system 102 may receive user input (e.g., as part of a search request, as a configuration setting, etc.) specifying which types of electronic communications are to be searched.

The electronic communications in the collection 104 are electronic communications of a user of the search system 102. The user of the search system 102 is, for example, a user that is logged into a particular account on the search system 102. The electronic communications in the collection 104 are sent by or received by the user of the search system 102. Each electronic communication in the collection 104 also has an associated individual that is the sender of the electronic communication in situations where the user of the search system 102 is the recipient of the electronic communication, and is the recipient of the electronic communication in situations where the user of the search system 102 is the sender of the electronic communication. The user and the individual associated with an electronic communication can be identified using various identifiers, such as email addresses, cell or other phone numbers, other account names or user names, and so forth. It should be noted that in the discussions herein referring to an individual that is the sender or recipient of an electronic communication, the individual can be a person, group of people, business or other corporate entity, government entity, and so forth.

The search system 102 includes a search term expansion module 122, an electronic communication search module 124, and an electronic communication ranking module 126. A user of the search system 102 provides a user input that is a search request requesting that the electronic communications collection 104 be searched for one or more input terms and/or based on other search criteria. These input terms can be at least part of the search criteria, and are one or more characters, such as a word (or portion of a word) or a phrase. Various logical operators (e.g., logical OR, logical AND) can be used to indicate how multiple input terms are to be combined. Various wildcard symbols can also be used in the input terms, for example to indicate any character or any combination of characters. The search request can optionally include additional search criteria, such as an indication of whether electronic communications that were sent by the user are to be searched, an indication of whether electronic communications that were received by the user are to be searched, a date or time range (e.g., the date or time an electronic communication was sent (or received), the date or time an electronic communication was interacted with) that electronic communications are to fall within in order to satisfy the search criteria, an indication of particular types of electronic communications that are to be searched, an indication of which parts of a particular type of electronic communication (e.g., email messages) are to be searched (e.g., the subject, the sender, the body, attachments, combinations thereof, etc.), an indication of whether the electronic communication attachments are to be searched, an indication of exclusions (e.g., one or more terms that an electronic communication cannot include in order to satisfy the search criteria), an indication of a particular type of attachment the electronic communication is to have, and so forth.

The search term expansion module 122 expands the user input terms to generate search terms for the search request. The module 122 can perform this expansion in different manners. In one or more embodiments, the module 122 expands the user input terms by identifying one or more additional terms that are semantically similar to one or more of the user input terms. Semantically similar terms can be identified in various manners, such as accessing various local or remote services that maintain synonyms for the input terms. For example, if the user were to enter “supper” as an input term, the module 122 may identify the word “dinner” as a semantically similar term. The input term and a semantically similar term can be treated as being logically OR'd together by the electronic communication search module 124, so that if a particular electronic communication satisfies the user input term or the semantically similar term, then that particular electronic communication satisfies the search criteria.

In one or more embodiments, the search term expansion module expands the user input terms by identifying translations of the one or more input terms into other languages. The other languages into which a user input term is translated can be identified in different manners, such as being other languages prominently used by the user that provided the search request. Such prominently used languages can be identified in different manners, such as based on configuration settings provided by the user, by analyzing the electronic communications collection 104 to determine languages used in the various electronic communications of the collection 104, and so forth. The input term and its one or more translations can be treated as being logically OR'd together by the electronic communication search module 124, so that if a particular electronic communication satisfies the user input term or the translation of the user input term, then that particular electronic communication satisfies the search criteria.

Additionally or alternatively, the module 122 can expand the user input terms in other manners. For example, the module 122 can expand the user input terms using stemming, such as by identifying grammatically related forms of the input terms. By way of another example, the module 122 can expand the user input terms using lemmatization, such as by identifying related words in the appropriate context.

The electronic communication search module 124 searches the electronic communications of the collection 104 to identify electronic communications that satisfy search criteria of the search request. This search criteria can include the one or more user input terms, and optionally one or more semantically similar terms and/or one or more translated terms. The one or more user input terms, one or more semantically similar terms, and/or one or more translated terms can be collectively referred to as the search terms corresponding to the search request. Additionally or alternatively, the search criteria can include other criteria as discussed above, such as particular types of electronic communications, particular data or time ranges, and so forth.

In one or more embodiments, an electronic communication satisfies the search criteria if the electronic communication includes the search terms. Whether all of the search terms are to be included in the electronic communication to satisfy the search criteria or some combination of search terms are to be included in the electronic communication to satisfy the search criteria (e.g., in what combination the search terms are to be treated as logically OR'd together and/or logically AND'd together) can be determined in different manners, such as being identified by the user in providing the search request. In one or more embodiments, an electronic communication satisfies the search criteria if it includes the input terms, the semantically similar terms, or the translated terms, but need not include all of the input terms, the semantically similar terms, and the translated terms.

In one or more embodiments, an electronic communication also satisfies the search criteria if the electronic communication is classified in a category having a category label that includes the search terms. Whether a category label includes the search terms can be determined in different manners, analogous to determining whether the electronic communication includes the search terms as discussed above. Electronic communications can be classified into different categories automatically and/or manually by the user. Each category has an associated category label that can optionally be defined by the user. For example, a particular category may have a category label of “airline tickets”, and search criteria that includes a search term of “tickets” is satisfied by each electronic communication that is classified in the “airline tickets” category regardless of whether the electronic communication actually includes the word “tickets”.

In one or more embodiments, the search criteria includes no search terms. Nonetheless, an electronic communication satisfies the search criteria if the electronic communication includes or otherwise conforms to the search criteria. For example, if the search criteria is a type of electronic communication, then all electronic communications of that type satisfy the search criteria. By way of another example, if the search criteria is a particular date range, then all electronic communications that fall within that date range satisfy the search criteria.

Additionally, in one or more embodiments the search criteria can include a search scope specifying an identifier of a sender or recipient, and an electronic communication satisfies the search criteria if an identifier of the sender or recipient of the electronic communication includes the identifier specified in the search scope. Whether an identifier of the sender or recipient includes the identifier specified in the search scope can be determined in different manners, analogous to determining whether the electronic communication includes the search terms as discussed above. The search scope can be expanded to include different identifiers associated with the sender or recipient. For example, if the search scope specifies a particular email address, and the search system 102 includes or has access to information identifying a phone number or other user account name associated with the user having that particular email address, then the search scope can be expanded to include that phone number or other user account name. Thus, by indicating a search scope with one particular identifier for a sender or recipient, the search can be automatically extended to include other known identifiers for that same sender or recipient.

The electronic communication search module 124 identifies a set of electronic communications in the collection 104 that satisfy the search criteria of the search request. The set of electronic communications that satisfy the search criteria is made available to the electronic communication ranking module 126, which ranks the electronic communications in the set of electronic communications according to various social cues. Generally, the social cues are an indication of how the user interacts with individuals that are associated with the electronic communications. The rankings are determined by generating a weighted score for each electronic communication in the set of electronic communications based on the social cues. For each electronic communication, the social cues provide an indication of how the user interacts with a particular individual that is the sender or recipient of the electronic communication. Different social cues can have different weights associated with them that indicate how much they contribute to an overall score for each electronic communication. The weighted score is generated for each electronic communication based on these social cues, and the set of electronic communications are ranked based on these weighted scores. The rankings can optionally factor in user feedback from previous ranked sets of electronic communications that can alter the weighted scores as discussed in more detail below.

The electronic communication ranking module 126 outputs an indication of the rankings of electronic communications in the set electronic communications. The module 126 can output this indication of rankings in different manners. In one or more embodiments, the module 126 displays the set of electronic communications to the user of the search system 102 in the order of the rankings. Alternatively, the indication of rankings can be provided to another device or service that displays the set of electronic communications that satisfy the search criteria, can be used to generate a report that is saved or communicated to another device or service, and so forth.

It should be noted that, depending on the social cues used by the electronic communication ranking module 126, various monitoring of statistics regarding electronic communications may be performed. This monitoring can be performed by the search system 102 or alternatively other systems (e.g., a system providing email functionality and on which email messages 106 are accessed), and includes monitoring actions taken by the user for particular electronic communications. This monitoring can include, for example, whether a user: read an electronic communication or deleted the electronic communication without reading it, marked an electronic communication as read without having read the electronic communication, moved an electronic communication to a folder, forwarded or replied to an electronic communication, categorized an electronic communication, marked an electronic communication for follow up (e.g., flagged an electronic communication), shared or saved an electronic communication on another platform (e.g., network drive, social networking service), marked an electronic communication as junk (or phishing, abuse, spam), unsubscribed from electronic communications (e.g., initiated an unsubscribe operation for newsletters or bulk mail), and so forth.

Although some of the discussions herein regarding the social cue based electronic communication ranking techniques refer to searching electronic communications collection 104, it should be noted that the techniques discussed herein can be implemented on any set of electronic communications, regardless of whether a search is performed based on particular input terms or other search criteria. For example, other search criteria can be used rather than input terms as discussed above (which may also be referred to as a “search all” option). Additionally, the techniques discussed herein can be used to provide a default or sorted view for a program or service. For example, rather than searching for particular electronic communications, all types of electronic communications supported by the program or service can be ranked and displayed (or otherwise presented) to the user. Furthermore, the techniques discussed herein can also be used to rank electronic communications previously searched or searched by another system or program. For example, another system or program can provide a set of electronic communications that can be ranked using the techniques discussed herein.

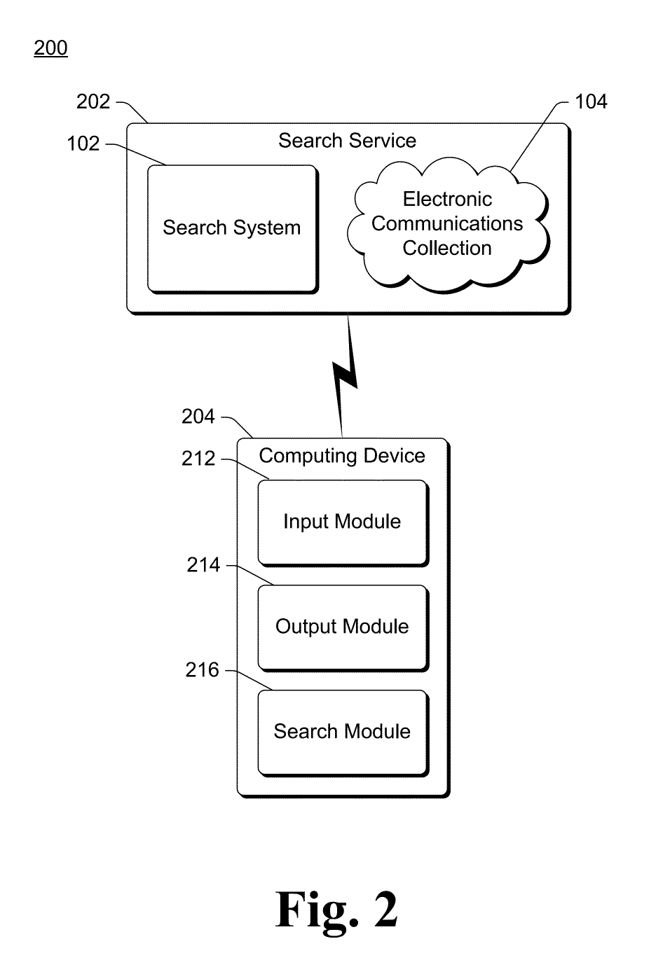

The social cue based electronic communication ranking techniques discussed herein can be implemented in a variety of different systems. FIG. 2 illustrates an example system 200 implementing the social cue based electronic communication ranking in accordance with one or more embodiments. System 200 includes a search service 202 that implements the search system 102 and also includes or otherwise has access to the electronic communications collection 104. A computing device 204 can communicate with the search service 202 via any of a variety of different networks. The computing device 204 includes an input module 212, an output module 214, and a search module 216. The computing device 204 can be any of a variety of different types of devices, analogous to the discussion above regarding devices that may implement the search system 102.

The input module 212 receives user inputs from a user of the computing device 204. User inputs can be provided in a variety of different manners, such as by pressing one or more keys of a keypad or keyboard of the device 204, pressing one or more keys of a controller (e.g., remote control device, mouse, track pad, etc.) of the device 204, pressing a particular portion of a touchpad or touchscreen of the device 204, making a particular gesture on a touchpad or touchscreen of the device 204, and/or making a particular gesture on a controller (e.g., remote control device, mouse, track pad, etc.) of the device 204. User inputs can also be provided via other physical feedback input to the device 204, such as tapping any portion of the device 204, an action that can be recognized by a motion detection or other component of the device 204 such as shaking the device 204, rotating the device 204, bending or flexing the device 204, etc.), and so forth. User inputs can also be provided in other manners, such as via voice or other audible inputs to a microphone, via motions of hands or other body parts observed by an image capture device, and so forth.

The output module 214 generates, manages, and/or outputs content for display, playback, and/or other presentation. This content can include a set of electronic communications that satisfy search criteria and are ranked using the techniques discussed herein. The content can be displayed or otherwise played back by components of the device 204 (e.g., speakers, interactive display devices, etc.). Alternatively, the output module 214 can generate one or more signals that are output to other devices or components (e.g., speakers, display devices, etc.) that are separate from the device 204.

The search module 216 receives, by way of the input module 212, the search request from the user along with at least some search criteria. The search module 216 provides the search request and search criteria to the search system 102, which performs the search and returns to the search module 216 a set of electronic communications that satisfy the search criteria and are ranked using the techniques discussed herein. These search results can then be displayed or otherwise output by the output module 214, for example by displaying the set of electronic communications in the order of their rankings.

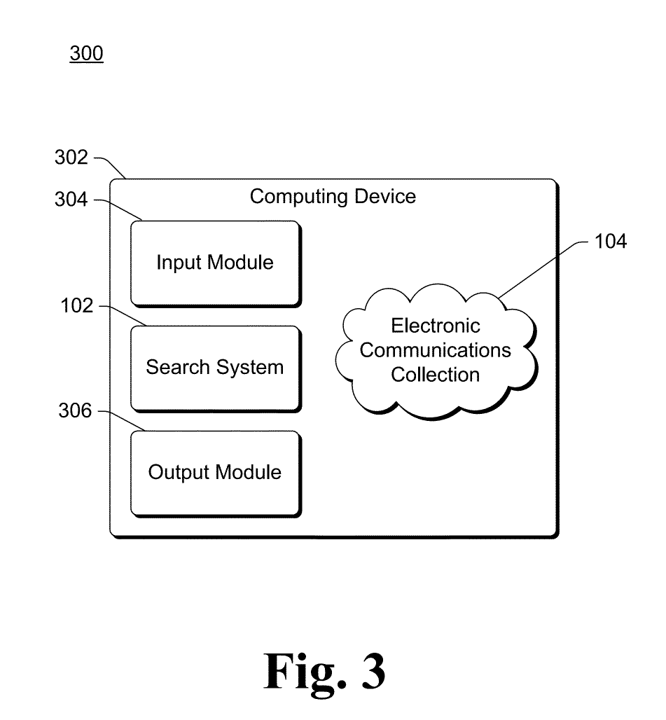

FIG. 3 illustrates another example system 300 implementing the social cue based electronic communication ranking in accordance with one or more embodiments. System 300 includes a computing device 302 that implements the search system 102 and also includes or otherwise has access to the electronic communications collection 104. The computing device 302 can be any of a variety of different types of devices, analogous to the discussion above regarding devices that may implement the search system 102.

The computing device also includes an input module 304 analogous to the input module 212 of FIG. 2, and an output module 306 analogous to the output module 214 of FIG. 2. The search system 102 receives, by way of the input module 212, the search request from the user along with the search criteria. The search system 102 performs the search and generates the set of electronic communications that satisfy the search criteria and are ranked using the techniques discussed herein. These search results can then be displayed or otherwise output by the output module 306, for example by displaying the set of electronic communications in the order of their rankings.

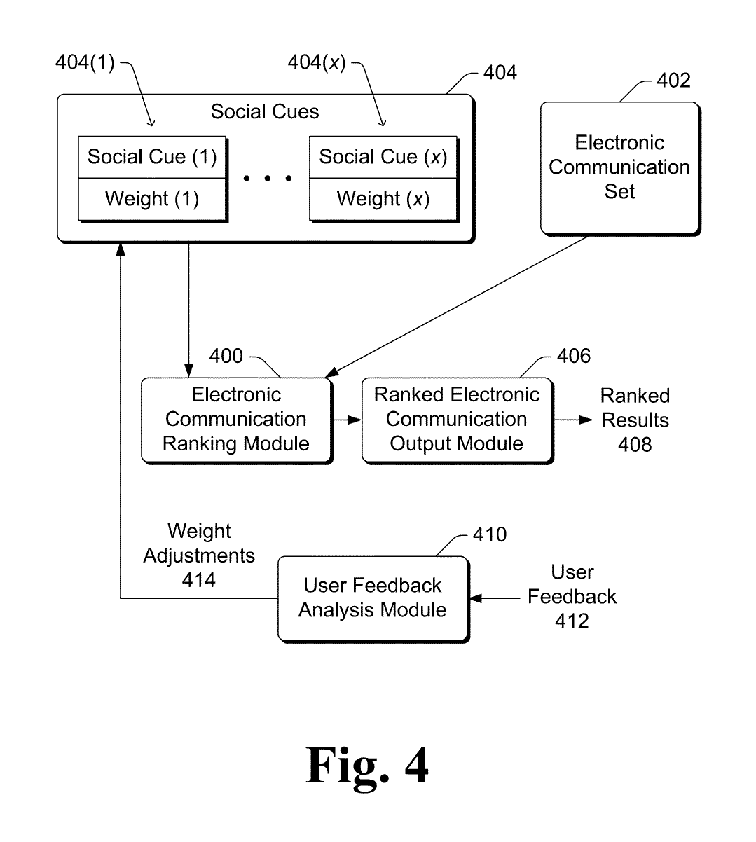

FIG. 4 illustrates operation of an example electronic communication ranking module 400 in accordance with one or more embodiments. The ranking module 400 can be, for example, the ranking module 126 of FIGS. 1, 2, and/or 3. The module 400 receives or otherwise accesses a set of electronic communications 402. The set 402 can be a set of electronic communications that satisfy particular search criteria as discussed above, or alternatively obtained from other sources and/or in other manners. The module 400 ranks the electronic communications in the set 402 using various different social cues 404. Multiple (x) social cues 404(1), . . . , 404(x) are illustrated, each having an associated weight. As indicated above, the social cues provide an indication of how the user interacts with individuals that are associated with the electronic communications in the set 402.

For each electronic communication in the set 402, the electronic communication is analyzed in light of the social cues 404. In applying a social cue 404 to an electronic communication, the ranking module 400 generates a value for that social cue 404 for that electronic communication. The generated value can be altered by applying the weight associated with the social cue 404 to the value for that social cue, such as by multiplying the weight by the value. The result of applying the weight to the value for a social cue is referred to as a weighted score for that social cue. The weighted scores for the social cues applied to a particular electronic communication can be combined to generate a weighted score for that particular electronic communication. The weighted scores for the social cues can be combined in different manners, such as being added together, multiplied, averaged, and so forth.

Weighted scores for each of the electronic communications in the set 402 are generated and used to rank the electronic communications in the set 402. The weighted scores can be used to rank the electronic communications in the set 402 in different manners, such as in ascending order of weighted score or descending order of weighted score. The rankings are provided to or otherwise made available to a ranked electronic communication output module 406, which outputs an indication of the ranking of the electronic communications in the set 402 as ranked results 408. The output module 406 can be a presentation module that displays or otherwise presents the ranked results 408 (analogous to the output module 214 discussed above), such as displaying the electronic communications in the order of their rankings. Alternatively, the output module 406 can output the indication of the ranked results 408 in other manners, such as storing the ranked results 408, using the ranked results 408 to generate a report or other data, providing an indication of the rankings to another module or system (e.g., which can store the ranked results 408 or use the ranked results 408 to generate a report or other data), and so forth.

In one or more embodiments, the electronic communications in the set 402 are displayed or otherwise presented as the ranked results 408 in the order of their rankings. The order of presentation of the electronic communications in the set 402 thus varies based on the rankings generated by the ranking module 400. This order of presentation can optionally change over time as the weights associated with the social cues 404 are adjusted over time based on user feedback as discussed in more detail below.

The weights associated with the social cues 404 can be determined in different manners. In one or more embodiments, initial or default values for the weights are determined by a user or designer of the electronic communication ranking module 400, such as based on empirical observations, knowledge or expectations of the user or designer, and so forth. Different weights can have different initial or default values, or alternatively multiple weights can have the same initial or default value. The weights associated with the social cues 404 can optionally be adjusted over time based on user feedback, as discussed in more detail below.

In some of the discussions herein example values generated for social cues and weights associated with social cues are discussed. It should be noted that these values are examples, and that other values and/or weights can be used, and other ranges of values and/or weights can be used. Regardless of the specific values used, the value generated by applying a social cue to an electronic communication provides an indication of how the user interacts with an individual that is the sender or recipient of the electronic communication. Values at one end of a value scale or range (e.g., higher values) can indicate a more frequent or stronger interaction with the individual than values at the other end of the value scale or range (e.g., lower values). Additionally, regardless of the specific weights associated with social cues, the weight associated with a social cue provides an indication of how much the value generated by applying that social cue to an electronic communication is to contribute to the weighted score of the electronic communication.

The techniques discussed herein can use various different social cues 404. In one or more embodiments, the social cues 404 include: a frequency of communication with the individual social cue, a most recent communication with the individual social cue, a frequency of truly read communications from the individual social cue, a frequency of communications from the individual marked as read but not actually read social cue, an assigned entity for the communication social cue, a social graph of the individual social cue, a location of the individual social cue, a reputation of the individual social cue, an information shared with the individual social cue, a date and/or time the communication was sent social cue, a calendar event existence social cue, an indication of a desired contact social cue, and a type of electronic communication social cue. It should be noted that these social cues are examples and that other social cues can alternatively be used as social cues 404, and similarly that some of these examples may not be used as social cues 404.

The frequency of communication with the individual social cue refers to how frequently the user communicates with the individual associated with the electronic communication relative to the individuals associated with the other electronic communications of the set 402. This social cue can be, for example, a most often communicated social cue identifying the individual associated with the electronic communications of the set 402 with which the user communicates most often. How frequently the user communicates with a particular individual can be based on the electronic communications in the collection 104 of FIG. 1, including electronic communications that are not included in the set 402. Alternatively, how frequently the user communicates with a particular individual can be based on a subset of the electronic communications in the collection 104 of FIG. 1, such as the electronic communications in the set 402. How frequently the user communicates with a particular individual can also be based on a log or other record of communications that are not included in the collection 104 of FIG. 1, such as phone calls placed using a communications program (e.g., an Internet calling program).

Values can be generated for the frequency of communication with the individual social cue for electronic communications in various manners. In one or more embodiments, in applying the frequency of communication with the individual social cue one value (e.g., 1 or 100) is generated for the electronic communication in the set 402 associated with the individual with which the user communicates most often, and another value (e.g., 0) is generated for all other electronic communications in the set 402. Alternatively, values can be generated in applying this social cue in other manners. For example, the individuals associated with the electronic communications of the set 402 may be ordered from most often communicated with to least often communicated with, and an electronic communication in the set 402 associated with an individual that the user communicates with more often is assigned a value greater than an electronic communication in the set 402 associated with an individual that the user communicates with less often.

The most recent communication with the individual social cue refers to how recently the user last communicated with the individual associated with the electronic communication. How recently the user last communicated with a particular individual can be based on the electronic communications in the collection 104 of FIG. 1, including electronic communications that are not included in the set 402. Alternatively, how recently the user last communicated with a particular individual can be based on a subset of the electronic communications in the collection 104 of FIG. 1, such as the electronic communications in the set 402. How recently the user last communicated with a particular individual can also be based on a log or other record of communications that are not included in the collection 104 of FIG. 1, such as phone calls placed using a communications program (e.g., an Internet calling program).

Values can be generated for the most recent communication with the individual social cue for electronic communications in various manners. In one or more embodiments, in applying the most recent communication with the individual social cue the individuals associated with the electronic communications of the set 402 may be ordered from most recently communicated with to least recently communicated with, and an electronic communication in the set 402 associated with an individual that the user communicated with more recently is assigned a value greater than an electronic communication in the set 402 associated with an individual that the user communicated with less recently. Alternatively, values can be generated in applying this social cue in other manners. For example, values can be assigned based on a number of days or hours since the individual associated with the electronic communication was last communicated with, such as one value (e.g., 50) if the individual associated with the electronic communication was most recently communicated with no more than one day ago, another value (e.g., 49) if the individual associated with the electronic communication was most recently communicated with between one and two days ago, and so forth.

The frequency of truly read communications from the individual social cue refers to how frequently the user reads electronic communications received from the individual associated with the electronic communications. An electronic communication being read or truly read refers to the user having read the electronic communication, for example as opposed to being deleted, saved, or otherwise managed without being read. An electronic communication can be determined to have been read by a user in different manners, such as in response to the electronic communication being displayed to the user for at least a threshold amount of time. This social cue can be, for example, a most truly read communications social cue identifying the individual associated with the electronic communications of the set 402 from which the user has read the most electronic communications. How many electronic communications from an individual the user truly reads can be based on the electronic communications in the collection 104 of FIG. 1, including electronic communications that are not included in the set 402. Alternatively, how many electronic communications from an individual the user truly reads can be based on a subset of the electronic communications in the collection 104 of FIG. 1, such as the electronic communications in the set 402.

Values can be generated for the frequency of truly read communications from the individual social cue for electronic communications in various manners. In one or more embodiments, in applying the frequency of truly read communications from the individual social cue one value (e.g., 1 or 100) is generated for the electronic communication in the set 402 associated with the individual from which the user has truly read the most electronic communications, and another value (e.g., 0) is generated for all other electronic communications in the set 402. Alternatively, values can be generated in applying this social cue in other manners. For example, the individuals associated with the electronic communications of the set 402 may be ordered from most truly read electronic communications to least truly read electronic communications, and an electronic communication in the set 402 associated with an individual from which the user truly reads more electronic communications is assigned a value greater than an electronic communication in the set 402 associated with an individual from which the user truly reads fewer electronic communications.

The frequency of communications from the individual marked as read but not actually read social cue refers to a frequency with which the user marks electronic communications from the individual as read without actually reading the electronic communications. Marking an electronic communication as read without actually reading the electronic communication can be performed in various manners, such as specifying that the electronic communication has been read, specifying that the electronic communication is spam, specifying that the electronic communication is junk mail, and so forth. Marking an electronic communication as read without actually reading the electronic communication can also be performed by specifying that the electronic communication is not related or otherwise not to be included, and the electronic communication ranking module 400 includes such electronic communications as having been marked as read without actually having been read (unless otherwise requested by the user). The frequency with which the user marks electronic communications from an individual as read without actually reading electronic communications can be based on the electronic communications in the collection 104 of FIG. 1, including electronic communications that are not included in the set 402. Alternatively, the frequency with which the user marks electronic communications from an individual as read without actually reading electronic communications can be based on a subset of the electronic communications in the collection 104 of FIG. 1, such as the electronic communications in the set 402.

Values can be generated for the frequency of communications from the individual marked as read but not actually read social cue for electronic communications in various manners. In one or more embodiments, in applying the frequency of communications from the individual marked as read but not actually read social cue a value is generated that is the percentage of communications from the individual that are marked as read but not actually read by the user (or other value is generated that is based on the percentage of communications from the individual that are marked as read but not actually read by the user). Alternatively, values can be generated in applying this social cue in other manners. For example, the individuals associated with the electronic communications of the set 402 may be ordered from least number of electronic communications marked as read but not actually read to most number of electronic communications marked as read but not actually read, and an electronic communication in the set 402 associated with an individual from which the user marks fewer electronic communications as read without actually reading the communications is assigned a value greater than an electronic communication in the set 402 associated with an individual from which the user marks more electronic communications as read without actually reading the communications.

The assigned entity for the communication social cue refers to an entity to which the electronic communication is assigned or in which the electronic communication is classified. An entity can be any grouping or collection of electronic communications, such as categories, folders, filters, archived communications, blocked senders lists, allowed senders lists, reminder flags (such as “follow up” or “for review”) and so forth. An entity can be user-defined or alternatively defined by the system (e.g., defined by the designer of electronic communication ranking module 400, generated automatically by the module 400). The assigned entity can be, for example, a category having a category label that includes the search terms as discussed above.

Values can be generated for the assigned entity for the communication social cue for electronic communications in various manners. In applying the assigned entity for the communication social cue a value is generated for an electronic communication based on the entity to which the electronic communication is assigned or in which the electronic communication is classified. Different entities can have different values that can be assigned in various manners. For example, the different values can be assigned by an administrator or designer of the electronic communication ranking module 400, by a user (e.g., providing indications of which entities are deemed to be of more importance than others to the user), and so forth.

The social graph of the individual social cue refers to a perceived connection that the user has with the individual. The perceived connection that the user has with the individual refers to how active the user is in communicating with the individual, as determined based on what the user does with electronic communications received from the individual. A perceived connection that the user has with a particular individual can be based on the electronic communications in the collection 104 of FIG. 1, including electronic communications that are not included in the set 402. Alternatively, a perceived connection that the user has with a particular individual can be based on a subset of the electronic communications in the collection 104 of FIG. 1, such as the electronic communications in the set 402.

Values can be generated for the social graph of the individual social cue for electronic communications in various manners. In applying the social graph of the individual social cue a value is generated for an electronic communication based on various characteristics of electronic communications with the individual. In one or more embodiments, the characteristics include a number of times that the user sends electronic communications to the individual and the nature of the sending (e.g., did the user send the electronic communication by replying to a previous electronic communication, did the user send the electronic communication by forwarding a previous electronic communication, did the user flag the electronic communication (e.g., for follow-up or future reference), did the user assign the electronic communication to a particular entity, what type of electronic communication did the user send, and so forth). The generated value can be, for example, a count or frequency of the user sending electronic communications to the individual (or other value that is based on the count or frequency of the user sending electronic communications to the individual). This generated value can be increased or decreased based on the nature of the sending (e.g., increasing the value by a factor if the user sent the electronic communication by forwarding a previous electronic communication rather than replying to a previous electronic communication, increasing the value by a factor if the user assigned the electronic communication to a particular entity (e.g., for archival), and so forth).

The characteristics can also include a number of times that the user receives electronic communications from the individual and the nature of the receiving (e.g., did the user receive the electronic communication in response to a previous electronic communication, did the user receive the electronic communication as a forwarded previous electronic communication, what type of electronic communication did the user receive, what action did the user take on the electronic communication (e.g., did the user flag the electronic communication (e.g., for follow-up or future reference), did the user mark the electronic communication as spam or junk, did the user reply to the electronic communication, did the user forward the electronic communication to another recipient, did the user assign the electronic communication to a particular entity, did the user listen to or download and attachment to the electronic communication, and so forth)). The characteristics can also include how quickly an action was taken on a communication (e.g., how quickly did the user reply to the electronic communication, how quickly did the user mark the electronic communication as spam or junk, and so forth). The generated value can be, for example, a count or frequency of the user receiving electronic communications from the individual (or other value that is based on the count or frequency of the user receiving electronic communications from the individual). This generated value can be increased or decreased based on the nature of the receiving (e.g., increasing the value by some factor if the user received the electronic communication as a forwarded electronic communication rather than in reply to a previous electronic communication, increasing the value by some factor if the user assigned the electronic communication to a particular entity (e.g., for archival), decreasing the value by some factor if the user marked the electronic communication as junk (e.g., the factor being greater if the user marked the electronic communication as junk shortly (within a threshold amount of time) after receipt of the electronic communication than if the user delayed in marking the electronic communication as junk), and so forth).

The characteristics can also include a number of times that the user read electronic communications received from the individual. The generated value can be, for example, a count or frequency of the user reading electronic communications received from the individual (or other value that is based on the count or frequency of the user reading electronic communications received from the individual).

The characteristics can also include a number of times that the user marked as unread electronic communications received from the individual. The generated value can be, for example, a count or frequency of the user marking electronic communications received from the individual as unread after having read the electronic communications (or other value that is based on the count or frequency of the user marking electronic communications received from the individual as unread after having read the electronic communications).

The characteristics can also include a number of times that the user deleted electronic communications received from the individual without reading the electronic communications. The generated value can be, for example, a count or frequency of the user deleting electronic communications received from the individual without having read the electronic communications (or other value that is based on the count or frequency of the user deleting electronic communications received from the individual without having read the electronic communications).

The characteristics can also include a number of times that the user did not accept a meeting invite or other calendar request (e.g., declined a meeting invite, did not reply to a meeting invite). The generated value can be, for example, a count or frequency of the user not accepting a meeting invite or other calendar request received from the individual (or other value that is based on the count or frequency of the user not accepting a meeting invite or other calendar request received from the individual).

The characteristics can also include a connection rank for the electronic communication received from or sent to the individual. The connection rank for an electronic communication received from the individual refers to how many recipients the electronic communication was sent to. The generated value can be, for example, based on the count of the number of recipients where a 1 to 1 electronic communication has a higher rank than a 1 to N electronic communication and where N refers to the recipient count. E.g., the generated value can be a rank of 1/N for electronic communications with N recipients.

The characteristics can also include a relative connection strength for the electronic communication received from or sent to the individual. The relative connection strength for an electronic communication received from the individual refers to an indication of recipients of an electronic communication with which the user does not actively communicate (e.g., in situations in which the user receives an electronic communication from both one or more users with which he or she actively communicates and one or more users with which he or she does not actively communicate). Whether a user actively communicates with an individual can be determined in various manners, such as based on whether the user reads electronic communications from the individual (indicating does actively communicate), based on how frequently the user sends electronic communications to the individual (indicating does actively communicates), based on whether the user deletes electronic communications from the individual without reading the electronic communications (indicating does not actively communicate), based on whether the user marks electronic communications from the individual as junk (indicating does not actively communicate), and so forth.

For the relative connection strength characteristic the generated value can be, for example, a relative connection strength value for the individual that is not actively communicated with by the user, the relative connection strength value being a count (or other value that is based on the count) of how many permutations of recipients of electronic communications include the individual. For example, assume the user receives electronic communications from individual A, individual B, individual C, and individual D with the permutations of: individuals A, B, and C; individuals A, C, and D; individuals A, B, and D; and individuals A and D. If the user actively communicates with individual A (e.g., almost always reads and performs an operation on electronic communications from individual A) but does not actively communicate with individuals B, C, and D (e.g., almost never reads or performs an operation on electronic communications from individuals B, C, and D), then the relative connection strength value for individual B with respect to user A is 2, the relative connection strength value for individual D with respect to user A is 3, and the relative connection strength value for individual C with respect to user A is 2.

The values for these different characteristics for the social graph of the individual social cue can be combined (e.g., added together, multiplied, averaged, etc.) to generate a value for the social graph of the individual social cue. Alternatively, different social cues and thus different values can be generated for each of these characteristics. For example, the social graph of the individual social cue can include a number of times the user sends electronic communications to the individual social graph of the individual social cue, a number of times an electronic communication is received from an individual social graph of the individual social cue, and so forth.

The location of the individual social cue refers to a physical location of the individual associated with the electronic communication. The location of the individual associated with an electronic communication can be determined in different manners, such as a network address (e.g., Internet Protocol (IP) address) from which the electronic communication was sent, a phone number of a device from which the electronic communication was sent, a location of the individual obtained from a location or tracking service approved by the individual, presence information obtained from another service (e.g., a communication service, a social networking service), and so forth.

Values can be generated for the location of the individual social cue for electronic communications in various manners. In one or more embodiments, in applying the location of the individual social cue a value is generated that is an indication of how physically close the user is to an individual associated with the electronic communication. Given the location of the user as well as the individual, how physically close the user is to an individual associated with the electronic communication can be readily determined. For example, the individuals associated with the electronic communications of the set 402 may be ordered from furthest away to closest, and an electronic communication in the set 402 associated with an individual that is closer to the user is assigned a value greater than an electronic communication in the set 402 associated with an individual that is further away from the user. By way of another example, the generated value for an electronic communication can be an estimated physical distance (e.g., in meters or kilometers) between the user and the individual associated with the electronic communication (or other value that is based on the physical distance between the user and the individual associated with the electronic communication). How physically close the user is to an individual associated with the electronic communication can be determined based on the current location of the individual associated with the electronic communication, or based on the location of the individual associated with the electronic communication when the communication originated.

It should be noted that in applying the location of the individual social cue, the physical location of the user of the search system may be determined. The physical location of the user can be determined in various manners, such as based on various location tracking technologies or services used by the user and/or a device of the user. The determination of the physical location of the user is made after receiving user approval to do so—if the user does not approve of his or her physical location being determined then his or her physical location is not determined and the location of the individual social cue need not be used. If the determination of the physical location of the user is made, no record identifying the user nor the physical location of the user need be maintained.

The reputation of the individual social cue refers to a reputation of the individual associated with the electronic communication. The reputation of the individual can be determined in different manners, such as by accessing a reputation tracking service via a network. Values can be generated for the reputation of the individual social cue for electronic communications in various manners. In applying the reputation of the individual social cue a value is generated that is an indication of the reputation of the individual associated with the electronic communication. For example, the individuals associated with the electronic communications of the set 402 may be ordered from highest reputation to lowest reputation, and an electronic communication in the set 402 associated with an individual having a higher reputation is assigned a value greater than an electronic communication in the set 402 associated with an individual having a lower reputation. By way of another example, the reputation of the individual may be a score or rating, and that score or rating (or other value based on the score or rating) can be the value generated for the electronic communication.

The information shared with the individual social cue refers to whether the user shares various information with the individual associated with the electronic communication. This sharing of information can take various forms, such as the individual associated with the electronic communication being granted read access or write access privilege to a device of the user, the user sharing a networked folder (or drive, or document, etc.) with the individual associated with the electronic communication, and so forth. Values can be generated for the information shared with the individual social cue for electronic communications in various manners. In one or more embodiments, in applying the information shared with the individual social cue one value (e.g., 1 or 100) is generated for an electronic communication in the set 402 associated with an individual that the user shares information with, and another value (e.g., 0) is generated for all other electronic communications in the set 402.

The date and/or time the communication was sent social cue refers to the date and/or time that the electronic communication was sent by the user or the individual associated with the electronic communication. Values can be generated for the date and/or time the communication was sent social cue for electronic communications in various manners. In one or more embodiments, in applying the date and/or time the communication was sent social cue the electronic communications of the set 402 may be ordered from most recently communicated (sent or received) to least recently communicated, and an electronic communication in the set 402 that is more recently communicated is assigned a value greater than an electronic communication in the set 402 that is less recently communicated. Alternatively, values can be generated in applying this social cue in other manners. For example, values can be assigned based on a number of days or hours since the electronic communication was communicated, such as one value (e.g., 50) if the communication was communicated no more than one day ago, another value (e.g., 49) if the communication was communicated between one and two days ago, and so forth.

The calendar event existence social cue refers to one or more calendar events with the individual associated with the electronic communication existing. The calendar events can refer to events such as meetings and appointments reflected in a calendar of the user. The events can be currently occurring events, past events, future events or combinations thereof. Values can be generated for the calendar event existence social cue for electronic communications in various manners. In applying the calendar event existence social cue a value is generated that is an indication of the existence of calendar events with the individual associated with the electronic communication. For example, the value can be one of two values indicating that no calendar events exist for individual (e.g., a value of 0) or that at least one calendar event exists for the individual (e.g., a value of 1 or 100). By way of another example, the value can be a count of how many calendar events exist for the individual, a count of how many calendar events exist for the individual within a particular date and/or time range, and so forth.

The indication of a desired contact social cue refers to the individual associated with the electronic communication being identified as a desired contact of the user. An individual can be identified as a desired contact of the user in a variety of manners, such as being included in an address book or contacts store of the user, being identified as a favorite or preferred contact, and so forth. Values can be generated for the indication of a desired contact social cue for electronic communications in various manners. In applying the indication of a desired contact social cue a value is generated that is an indication of whether the individual is a desired contact of the user. For example, the value can be one of two values indicating that the contact is not a desired contact of the user (e.g., a value of 0) or is a desired contact of the user (e.g., a value of 1 or 100). By way of another example, the value can vary based on how the individual is indicated as being a desired contact (e.g., a higher value may be used if the individual is identified as a preferred contact of the user than if the individual is identified in an address book of the user).

The type of electronic communication social cue refers to the type of the electronic communication itself. Values can be generated for the type of electronic communication social cue for electronic communications in various manners. In applying the type of electronic communication social cue a value is generated that is an indication of an importance given to the particular type of electronic communication (e.g., the user may give more importance to email messages than SMS messages). For example, different types of electronic communication can be deemed to be of more importance to the user than others, and electronic communications of a type deemed to be of more importance to the user have higher values than electronic communications of a type deemed to be of less importance to the user.

Additionally, as illustrated in FIG. 4, a user feedback analysis module 410 receives user feedback 412 from a user of the search service. The user feedback analysis module 410 analyzes the user feedback 412 to identify an accuracy of the ranked results 408 and determine adjustments to be made to the weights associated with the social cues 404. Based on this analysis, weight adjustments 414 are made to the weights associated with the social cues 404.

The user feedback analysis module 410 can determine adjustments to be made to the weights associated with social cues 404 in different manners, optionally depending on the nature of the user feedback 412. In adjusting the weights associated with the social cues 404, a weight can be increased or decreased. A weight can be increased or decreased by a fixed amount (e.g., 0.7 or 10), or can be increased or decreased by a relative amount (e.g., 10% or 25% of the previous value of the weight).

In one or more embodiments, the user feedback 412 is a user identification of particular social cues that the user deems most applicable to him or her. In response to such user feedback, the analysis module 410 increases the weights associated with the social cues deemed the most applicable to the user and/or decreases the weights associated with the social cues that are not deemed the most applicable to the user.

Alternatively, the user feedback analysis module 410 can automatically identify which social cues are to have their associated weights adjusted. In such situations, the module 410 identifies whether the user feedback 412 indicates an adjustment in social cue weights is appropriate. This identification can be performed in various manners. For example, the user feedback 412 can be an indication of which of the electronic communications presented to the user are selected by the user (e.g., selected for reading, selected for forwarding, selected for archiving, and so forth). If the highest ranked electronic communication is selected, or alternatively if one of a threshold number of highest ranked electronic communications is selected (e.g., one of the three highest ranked electronic communications), then the module 410 can determine that no adjustment to the social cue weights is appropriate.

However, if the electronic communication that is selected for at least a threshold number (or threshold percentage) of output results 408 is not the highest ranked, or is not one of a threshold number of highest ranked, electronic communications then the module 410 can determine that an adjustment to the social cue weights is appropriate. This determination can be made, for example, due to the module 410 assuming that the ranking of the electronic communications can be adjusted so that the accuracy of the ranking can be increased and so that for future rankings a highest ranked, or one of a threshold number of highest ranked, electronic communications would be selected by the user. The module 410 can determine the amount of the adjustment of the weights in different manners.

In one or more embodiments, the module 410 identifies the scores for social cues for the selected electronic communication as well as for one or more higher ranked electronic communications, and determines which social cues had higher scores for the selected electronic communication than for the one or more higher ranked electronic communications. The weights of those social cues for which the selected electronic communication had higher scores are decreased. Alternatively, the module 410 can determine which social cues had higher scores for the one or more higher ranked electronic communications than for the selected electronic communication, and the weights of those social cues for which the one or more higher ranked electronic communications had higher scores are increased.

It should be noted that although the user feedback analysis module 410 is discussed as adjusting the weights associated with social cues 404 based on user feedback, the weights can additionally or alternatively be adjusted in other manners. For example, a system administrator or developer may adjust weights associated with social cues based on offline user studies, other empirical data, and so forth.

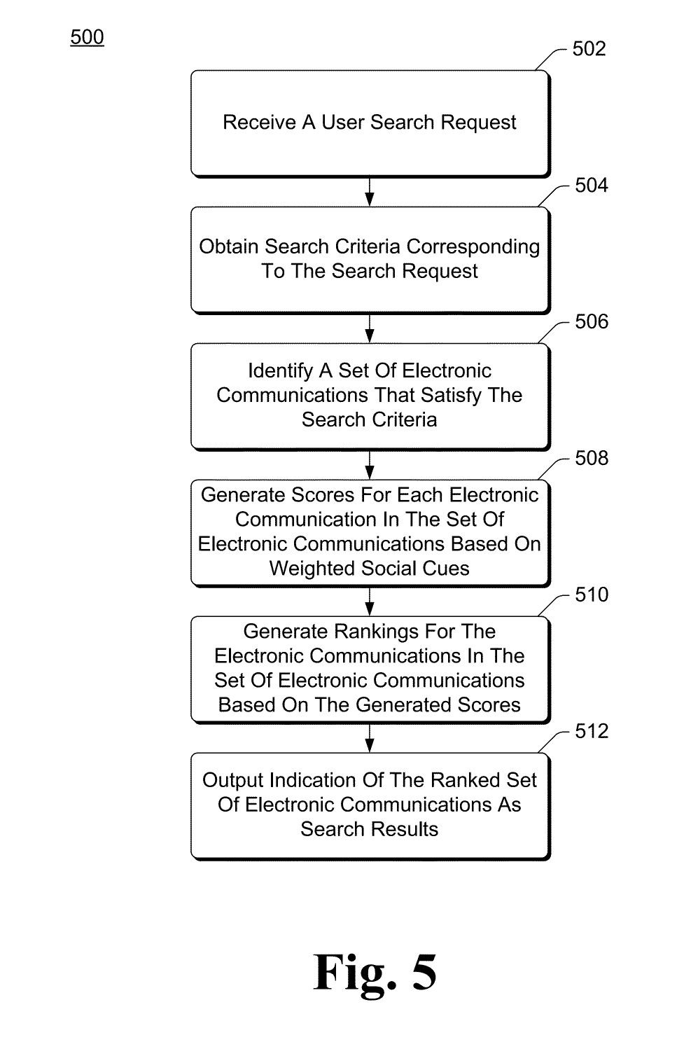

FIG. 5 is a flowchart illustrating an example process 500 for generating social cue based rankings for electronic communications in accordance with one or more embodiments. Process 500 is carried out by a search system, such as search system 102 of FIG. 1, 2, or 3, and can be implemented in software, firmware, hardware, or combinations thereof. Process 500 is shown as a set of acts and is not limited to the order shown for performing the operations of the various acts. Process 500 is an example process for generating social cue based rankings for electronic communications; additional discussions of generating social cue based rankings for electronic communications are included herein with reference to different figures.

In process 500, a user search request is received (act 502), and search criteria corresponding to the search request are obtained (act 504). The search request includes at least some search criteria, such as one or more user input terms and/or other search criteria as discussed above. Additional search terms that are semantically similar to the one or more input terms and/or translations of the one or more input terms in other languages as discussed above can also be obtained.

A set of electronic communications that satisfy the search criteria are identified (act 506). The electronic communications that satisfy the search criteria can include those electronic communications that include a search term of the search criteria as well as electronic communications classified in a category having a category label that includes a search term as discussed above.

Scores for each electronic communication and a set of electronic communications are generated based on weighted social cues (act 508). Various different social cues that provide an indication of how the user interacts with a particular individual that is the sender or recipient of an electronic communication can be used, with different social cues having different associated weights that indicate how much they contribute to an overall score for each electronic communication as discussed above.

Rankings for the electronic communications in the set of electronic communications are generated (act 510). These rankings are generated based on the scores generated for the electronic communications in act 508.

An indication of the ranked set of electronic communications is output as search results in response to the search request (act 512). The output in act 512 can take various forms, such as displaying the ranked set of electronic communications, outputting identifiers of the electronic communications in the ranked set of electronic communications, and so forth as discussed above.

It should be noted that the scores for electronic communications can be generated in act 508 at various times. In one or more embodiments, the scores are generated in response to receipt of the user search request in act 502. Alternatively, the scores can be generated at other times, such as regularly or irregularly (e.g., overnight at a particular time, during times of low system resource usage, and so forth). The scores can also be generated in response to other events or actions, such as each time an electronic communication is received, each time the user takes an action on their electronic communications (e.g., an action that affects the scores being generated), and so forth. The scores can optionally be stored for subsequent retrieval (e.g., in response to receipt of a user search request in act 502).

It should also be noted that in process 500 the set of electronic communications is obtained as a set of electronic communications that satisfy search criteria corresponding to a user search request. Alternatively, the set of electronic communications can be identified in any manner, and need not be based on a user search request as discussed above.

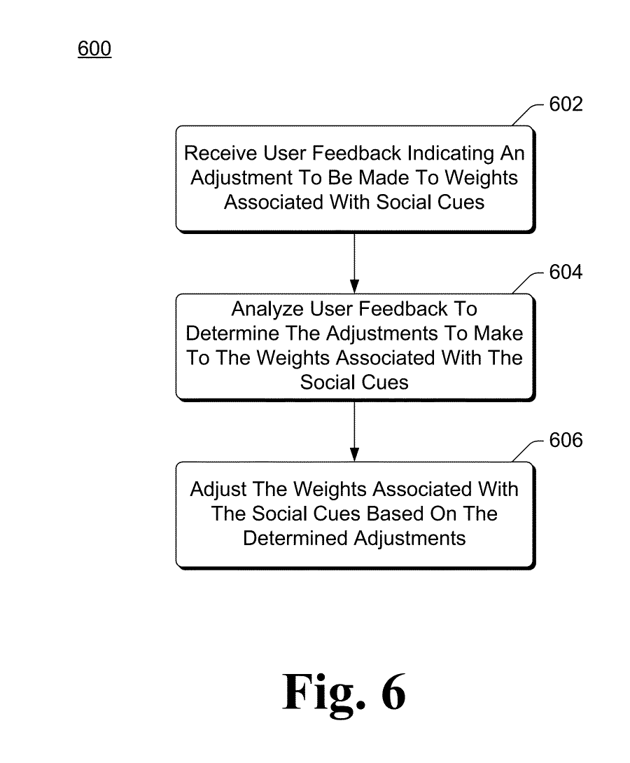

FIG. 6 is a flowchart illustrating an example process 600 for adjusting weights associated with social cues in accordance with one or more embodiments. Process 600 can be implemented in software, firmware, hardware, or combinations thereof. Process 600 is shown as a set of acts and is not limited to the order shown for performing the operations of the various acts. Process 600 is an example process for adjusting weights associated with social cues; additional discussions of adjusting weights associated with social cues are included herein with reference to different figures.

In process 600, user feedback indicating an adjustment to be made to weights associated with social cues is received (act 602). The user feedback can take various forms, such as a user identification of particular social cues that the user deems most applicable to him or her, a selection of a particular electronic communication in a ranked set of electronic communications, and so forth as discussed above.

The user feedback is analyzed to determine the adjustments to make to the weights associated with the social cues (act 604). The particular weights to be adjusted can be the weights associated with social cues identified by the user as part of the user feedback, or can be automatically determined as discussed above.

The determined adjustments are made to the weights associated with the social cues (act 606). These adjustments can include increasing or decreasing particular weights by fixed or relative amounts as discussed above.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

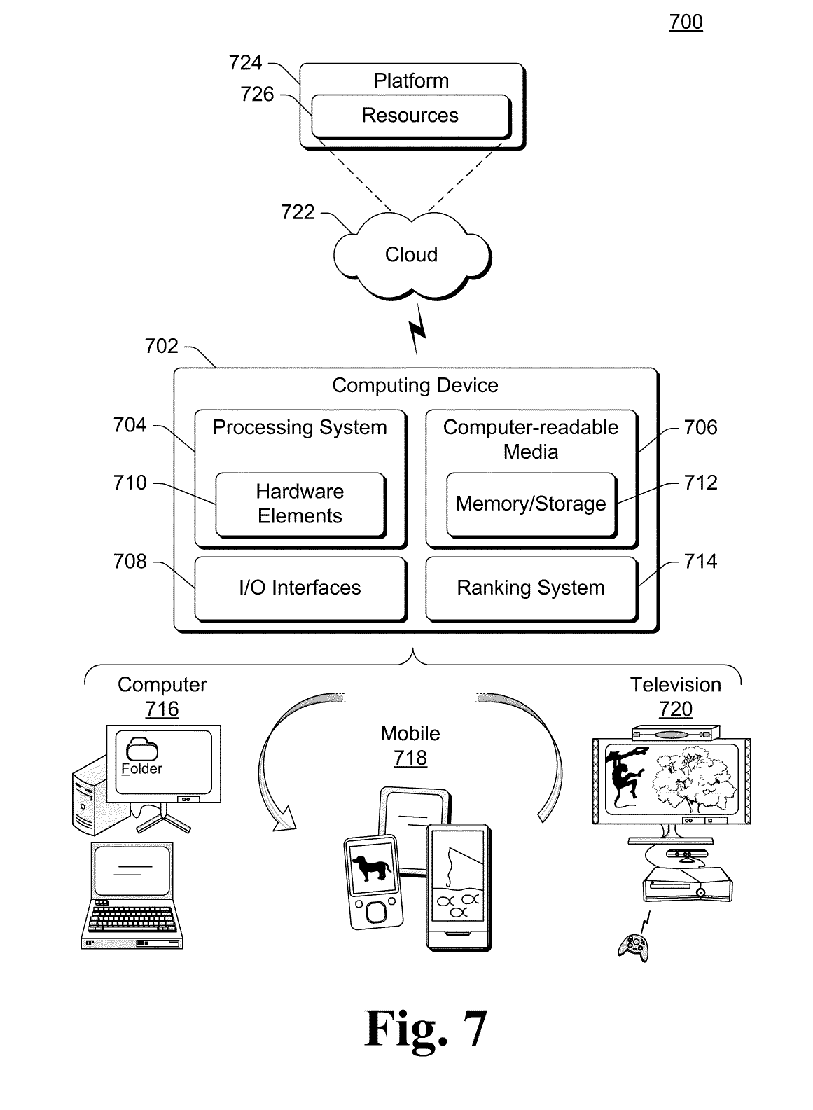

FIG. 7 illustrates an example system generally at 700 that includes an example computing device 702 that is representative of one or more systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O Interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

Computing device 702 also includes a ranking system 714. Ranking system 714 provides various social cue based electronic communication ranking functionality as discussed above. Ranking system 714, for example, can be search system 102 of FIG. 1, 2, or 3, or can be module 400, 406, and 410 of FIG. 4.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules as a module that is executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 702 may assume a variety of different configurations, such as for computer 716, mobile 718, and television 720 uses. Each of these configurations includes devices that may have generally different constructs and capabilities, and thus the computing device 702 may be configured according to one or more of the different device classes. For instance, the computing device 702 may be implemented as the computer 716 class of a device that includes a personal computer, desktop computer, a multi-screen computer, laptop computer, netbook, and so on.

The computing device 702 may also be implemented as the mobile 718 class of device that includes mobile devices, such as a mobile phone, portable music player, portable gaming device, a tablet computer, a multi-screen computer, and so on. The computing device 702 may also be implemented as the television 720 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This functionality may also be implemented all or in part through use of a distributed system, such as over a “cloud” 722 via a platform 724 as described below.

The cloud 722 includes and/or is representative of a platform 724 for resources 726. The platform 724 abstracts underlying functionality of hardware (e.g., servers) and software resources of the cloud 722. The resources 726 may include applications and/or data that can be utilized while computer processing is executed on servers that are remote from the computing device 702. Resources 726 can also include services provided over the Internet and/or through a subscriber network, such as a cellular or Wi-Fi network.

The platform 724 may abstract resources and functions to connect the computing device 702 with other computing devices. The platform 724 may also serve to abstract scaling of resources to provide a corresponding level of scale to encountered demand for the resources 726 that are implemented via the platform 724. Accordingly, in an interconnected device embodiment, implementation of functionality described herein may be distributed throughout the system 700. For example, the functionality may be implemented in part on the computing device 702 as well as via the platform 724 that abstracts the functionality of the cloud 722.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
generating, for each electronic communication in a set of electronic communications of a user, a score for each of multiple social cues that indicate how the user interacts with an individual in the electronic communication;
generating, for each electronic communication in the set of electronic communications, a ranking for the electronic communication based on the scores of the multiple social cues for the electronic communication; and
outputting an indication of the rankings for the set of electronic communications.

2. A method as recited in claim 1, further comprising:
obtaining search criteria corresponding to a user search request, the search criteria including one or more user input terms and one or more terms semantically similar to the one or more user input terms; and
identifying, as the set of electronic communications of the user, electronic communications that satisfy the search criteria.

3. A method as recited in claim 1, further comprising:
obtaining search criteria corresponding to a user search request, the search criteria including one or more user input terms and translations of the one or more user input terms into one or more other languages; and
identifying, as the set of electronic communications of the user, electronic communications that satisfy the search criteria.

4. A method as recited in claim 1, the individual comprising a sender of the electronic communication if the user is a recipient of the electronic communication, and the individual comprising the recipient of the electronic communication if the user is the sender of the electronic communication.

5. A method as recited in claim 1, the outputting the indication of the rankings comprising displaying one or more electronic communications of the set of electronic communications in the order of the rankings.

6. A method as recited in claim 1, wherein each of the multiple social cues has an associated weight, the score for each of the multiple social cues is a weighted score obtained by generating a value for the social cue by applying the social cue to the electronic communication and applying the weight associated with the social cue to the value for the social cue, the method further comprising:
generating, for each electronic communication in the set of electronic communications, a weighted score by combining the weighted scores of the multiple social cues for the electronic communication; and
the generating the ranking comprising generating the ranking based on the weighted scores of each electronic communication in the set of electronic communications.

7. A method as recited in claim 6, further comprising:
receiving user feedback indicating an adjustment to be made to one or more weights associated with the multiple social cues; and
adjusting the one or more weights based on the user feedback.

8. A method as recited in claim 1, the multiple social cues comprising a social graph social cue that identifies a perceived connection that the user has with the individual in the electronic communication.

9. A method as recited in claim 8, the generating a score for each of the multiple social cues comprising generating, for the social graph social cue, a value based on a number of times that the user sends electronic communications to the individual and the nature of the sending of the electronic communications to the individual.

10. A method as recited in claim 8, the generating a score for each of the multiple social cues comprising generating, for the social graph social cue, a value based on a number of times that the user receives electronic communications from the individual and the nature of the receipt of the electronic communications from the individual.

11. A method as recited in claim 8, the generating a score for each of the multiple social cues comprising generating, for the social graph social cue, a value based on a number of times that the user read electronic communications received from the individual.

12. A method as recited in claim 8, the generating a score for each of the multiple social cues comprising generating, for the social graph social cue, a value based on a number of times that the user marked electronic communications received from the individual as unread after having read electronic communications.

13. A method as recited in claim 8, the generating a score for each of the multiple social cues comprising generating, for the social graph social cue, a value based on a number of times that the user deleted electronic communications from the individual without having read electronic communications.

14. A method as recited in claim 8, the generating a score for each of the multiple social cues comprising generating, for the social graph social cue, a value based on a number of recipients in the electronic communication.

15. A method as recited in claim 1, the multiple social cues comprising one social cue that identifies an action that the user takes with previous electronic communications received from the individual, and an additional social cue that identifies an entity to which the electronic communication is assigned or in which the electronic communication is classified.

16. A system comprising:
an electronic communication ranking module configured to generate, for each electronic communication in a set of electronic communications of a user, a ranking for the electronic communication based on scores for each of one or more of multiple social cues indicating how the user interacts with an individual in the electronic communication; and
a ranked electronic communication output module configured to output the indication of the rankings for the set of electronic communications.

17. A system as recited in claim 16, further comprising an electronic communication search module configured to identify, as the set of electronic communications of the user, electronic communications that satisfy search criteria corresponding to a user search request.

18. A system as recited in claim 16, the multiple social cues comprising an assigned entity social cue that identifies the category in which the electronic communication is classified.

19. A system as recited in claim 16, the multiple social cues comprising a frequency of communication with the individual social cue, a most recent communication with the individual social cue, a frequency of truly read communications from the individual social cue, a frequency of communications from the individual marked as read but not actually read social cue, an assigned entity for the communication social cue, a social graph of the individual social cue, a location of the individual social cue, a reputation of the individual social cue, an information shared with the individual social cue, a date and time the communication was sent social cue, a calendar event existence social cue, an indication of a desired contact social cue, and a type of electronic communication social cue.

20. A system comprising:
an electronic communication search module configured to:
obtain search criteria corresponding to a user search request, and
identify a set of electronic communications of the user that satisfy the search criteria; and
an electronic communication ranking module configured to:
generate, for each electronic communication in the set of electronic communications, a weighted score for each of multiple social cues that indicate how the user interacts with an individual in the electronic communication, each social cue having an associated weight,
generate, for each electronic communication in the set of electronic communications, a ranking for the electronic communication based on the scores of the multiple social cues for the electronic communication, and
output an indication of the rankings for the set of electronic communications; and
a user feedback analysis module configured to:
automatically identify, based on user feedback, one or more social cues the associated weights of which are to be adjusted, and
increase or decrease, based on the user feedback, the weights associated with one or more of the multiple social cues.
